(19) United States
(12) Patent Application Publication
(10) Pub. No.: US 2014/0067886 A1
(43) Pub. Date: Mar. 6, 2014

(54) INFORMATION PROCESSING APPARATUS, METHOD OF OUTPUTTING LOG, AND RECORDING MEDIUM

(71) Applicant: Fujitsu Limited, Kawasaki-shi (JP)

(72) Inventors: Hiroko SAKANASHI, Hamamatsu (JP); Yuichiro SUZUKI, Shizuoka (JP); Minoru NITTA, Shizuoka (JP)

(73) Assignee: Fujitsu Limited, Kawasaki-shi (JP)

(21) Appl. No.: 14/016,978

(22) Filed: Sep. 3, 2013

(30) Foreign Application Priority Data
Sep. 4, 2012 (JP) 2012-193695

(51) Int. Cl. G06F 17/30

(52) U.S. Cl. CPC G06F 17/30091
USPC 707/825

(57) ABSTRACT

An information processing apparatus for executing a program, the information processing apparatus includes a memory, and a processor coupled to the memory. The processor is configured to set a detail level with regard to a log based on a number of times of prior execution of a program module called, the program module being included in the program, and output the log including information in accordance with the detail level.

### CROSS-REFERENCE TO RELATED APPLICATION

This application is based upon and claims the benefit of priority from the prior Japanese Patent Application No. 2012-193695 filed on Sep. 4, 2012, the entire contents of which are incorporated herein by reference.

### FIELD

The embodiments discussed herein are related to an information processing apparatus, a method of outputting a log, and a recording medium.

### BACKGROUND

Information processing apparatuses, such as a computer, and so on are provided with a function of outputting a log that indicates execution states of processing. For example, when a failure occurs in an information processing apparatus, the log output is used for investigation of the cause of the failure and modification of the program.

Also, a method of outputting only a log that is desired is thought in order to restrict the amount of log data to be output. For example, a method of outputting only a log of checkpoints that are set in the program in advance is known as a related art.

Also, information processing apparatuses having a function of varying the amount of log data to be output by changing a log level are known as related art. For example, one example of those apparatuses is an information processing apparatus capable of automatically changing a log level at abnormality occurrence time. Alternatively, an information processing apparatus having a function of generating a replicated process at the time of executing a certain process, and executing the replicated process with an increased log level in case of abnormal termination of the replication source process is known as related art.

Japanese Laid-open Patent Publication Nos. 2009-205488 and 2012-18512 are known as related art.

### SUMMARY

According to an aspect of the invention, an information processing apparatus for executing a program, the information processing apparatus includes a memory, and a processor coupled to the memory. The processor is configured to set a detail level with regard to a log based on a number of times of prior execution of a program module called, the program module being included in the program, and output the log including information in accordance with the detail level.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration and an example of operation of an information processing apparatus according to a first embodiment;

FIG. 2 is a diagram illustrating an example of a hardware configuration of an information processing apparatus according to a second embodiment;

FIG. 3 is a block diagram illustrating an example of a configuration of processing functions of the information processing apparatus;

FIG. 4 is a diagram illustrating an example of source code of a program to be monitored;

FIG. 5 is a diagram illustrating an example of a tree structure;

FIG. 6 is a diagram illustrating an example of information recorded in an execution-state management table;

FIG. 7 is a flowchart illustrating an example of processing of a log-level setting unit;

FIG. 8 is a flowchart illustrating an example of processing of a log output unit;

FIG. 9 is a diagram illustrating an example of a system configuration of an information processing system according to a third embodiment;

FIG. 10 is a block diagram illustrating an example of a configuration of processing functions of a host server;

FIG. 11 is a flowchart illustrating an example of inquiry processing by the log-level setting unit;

FIG. 12 is a diagram illustrating an example of information recorded in an execution-state management table; and

FIG. 13 is a flowchart illustrating an example of log-level setting processing.

### DESCRIPTION OF EMBODIMENTS

In the following, a description will be given of embodiments of the present disclosure with reference to the drawings.

### First Embodiment

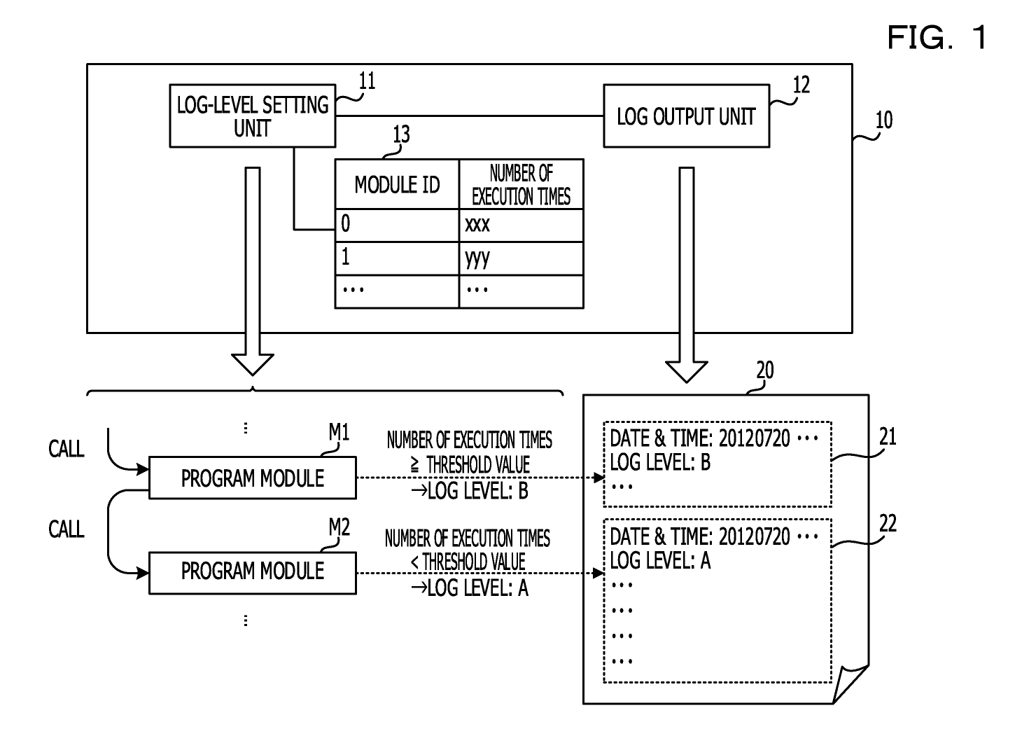

FIG. 1 is a diagram illustrating an example of a configuration and an example of operation of an information processing apparatus according to a first embodiment. An information processing apparatus 10 illustrated in FIG. 1 includes a processor (not illustrated in FIG. 1) that executes a predetermined program. Also, the information processing apparatus 10 has a function of outputting a log that describes program execution states of whether the program has been executed normally, and so on with the execution of the program.

The information processing apparatus 10 includes a log-level setting unit 11 and a log output unit 12. The log-level setting unit 11 and the log output unit 12 execute processing for controlling log output when a certain program (hereinafter, referred to as a program P1) including a plurality of program modules is executed in the information processing apparatus 10. The plurality of program modules individually include at least one function, for example. Also, each of the program modules is called and executed in accordance with the execution of the other program modules.

In this regard, processing of the log-level setting unit 11 and the log output unit 12 are achieved by the processor of the information processing apparatus 10 executing a log output program different from the above-described program P1.

The log-level setting unit 11 sets a log level on the basis of the number of prior execution times of a program module when one of the plurality of program modules included in the program P1 is called. The log level is, for example a parameter for determining a detail level with regard to information to be included in the log to be output. The higher the detail level with regard to information, the larger the amount of log data becomes. In this regard, the log level may be a parameter for determining whether or not to output the log.

The log output unit 12 outputs a log having the log level set by the log-level setting unit 11 (for example, a log including information in accordance with the detail level indicated by the log level). In FIG. 1, for example the log output unit 12 generates a log file 20, and writes a log of the set log level into the log file 20. The log file 20 is stored, for example in a nonvolatile storage unit included in the information processing apparatus 10.

By the information processing apparatus 10 like this, since a function of varying a log level is provided, it is possible to make the amount of log data in accordance with the desired amount, and thus to restrict the amount of data of the log file 20. Together with this, by setting the log level in accordance with the number of execution times of the program module called, it is possible to increase a probability of allowing output of the log having a high detail level at abnormality occurrence time.

For example, for a method of changing a log level, there is a method of determining the log level for outputting the log at execution time in advance for each program module included in the program P1. However, it is difficult to predict in advance which program module is executed at the time a failure is likely to occur among the program modules included in the program P1. Accordingly, by this method, there is a probability that a log having a high detail level is failed to be output when a failure actually occurs.

In contrast, the information processing apparatus 10 changes the log level in accordance with the actual execution state, which is the number of execution times of the program modules. By this processing, it is possible for the information processing apparatus 10 to increase the detail level with regard to the log when going to an execution state in which a failure is likely to occur actually on the basis of the analysis result of failure occurrences.

For example, a program module having a small number of execution times or a low execution frequency is more likely to have a failure at execution time than a program module having a large number of execution times or a high execution frequency. Accordingly, by setting the log level in accordance with the number of execution times of a program module having been called, it is possible for the information processing apparatus 10 to reduce the amount of data of the log file 20, and to increase the probability that allows output of detailed log at an appropriate time.

In the following, a description will be given of an example of the processing of the log-level setting unit 11 and the log output unit 12 at the time of executing the program P1. In this processing example, it is assumed that the information processing apparatus 10 includes a function of counting the number of execution times for each program module included in the program P1 after execution of the program P1 is started. And it is assumed that the counted number of execution times is recorded in the number of execution times table 13 illustrated in FIG. 1, and the log-level setting unit 11 references the number of execution times recorded in the number of execution times table 13.

In the number of execution times table 13, a module ID for identifying a program module and the number of execution times are associated. In this regard, the number of execution times table 13 may record not simply the number of execution times from the start of the execution of the program P1, but for example, the number of execution times for each predetermined time period (that is to say, an execution frequency) may be recorded for each program module.

It is assumed that first, a program module M1 was called by the execution of a certain program module (not illustrated in FIG. 1) included in the program P1. At this time, the log-level setting unit 11 refers to the number of execution times table 13, determines the number of prior execution times of the program module M1, and compares the number of execution times with a predetermined threshold value.

Here, if it is assumed that the number of execution times is not less than the threshold value, the log-level setting unit 11 sets a log level B. The log output unit 12 writes a log 21 in accordance with the log level B into the log file 20. In this regard, the log level B is a parameter for outputting the log having a lower detail level than a log level A described later.

Next, it is assumed that a program module M2 is called by execution of the program module M1. At this time, the log-level setting unit 11 refers to the number of execution times table 13, determines the number of prior execution times of the program module M2, and compares the number of execution times with the threshold value described above.

Here, if the number of execution times is lower than the threshold value, the log-level setting unit 11 sets the log level A for increasing the detail level with regard to the log higher than the log level B described above. The log output unit 12 writes the log 22 in accordance with the log level A into the log file 20. The log 22 includes descriptions of, for example a larger number of items than the log 21.

By the above processing, it is possible for the information processing apparatus 10 to increase the detail level with regard to the log to be output in accordance with the execution state of the program module in the case where it is thought that a failure is likely to occur. Accordingly, it is possible for the information processing apparatus 10 to increase the probability of allowing output of a detailed log when a failure occurs while keeping the amount of data of the log file 20 down.

### Second Embodiment

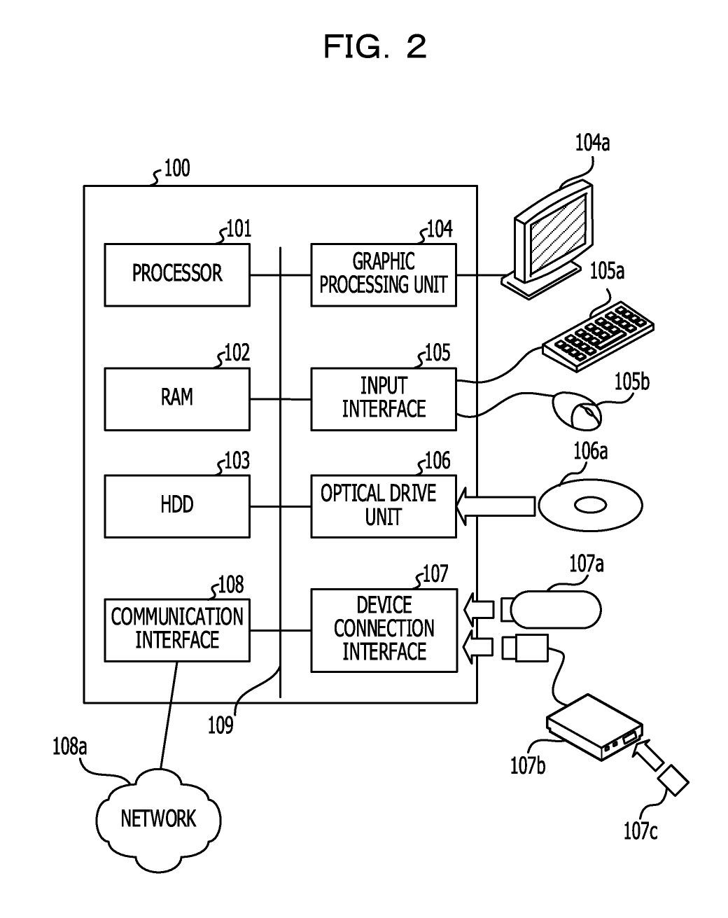

FIG. 2 is a diagram illustrating an example of a hardware configuration of an information processing apparatus according to a second embodiment. The information processing apparatus 100 is achieved, for example, as a computer illustrated in FIG. 2.

The entire apparatus of the information processing apparatus 100 is controlled by a processor 101. A random access memory (RAM) 102 and a plurality of peripheral devices are connected to the processor 101 through a bus 109. The processor 101 may be a multiprocessor. The processor 101 is, for example, a central processing unit (CPU), a micro-processing unit (MPU), a digital signal processor (DSP), an application specific integrated circuit (ASIC), or a programmable logic device (PLD). Also, the processor 101 may be a combination of two elements or more out of the CPU, the MPU, the DSP, the ASIC, and the PLD.

The RAM 102 is used as a main storage unit of the information processing apparatus 100. The RAM 102 temporarily stores at least a part of the program of the operating system (OS) and the application programs, which are to be executed by the processor 101. Also, the RAM 102 stores various kinds of data desired for the processing by the processor 101.

Peripheral devices connected to the bus 109 are, for example, a hard disk drive (HDD) 103, a graphic processor 104, an input interface 105, an optical drive unit 106, a device connection unit 107, and a communication interface 108.

The HDD 103 is used for an auxiliary storage unit of the information processing apparatus 100. The HDD 103 stores the OS program, application programs, and various kinds of data. In this regard, as an auxiliary storage unit, a nonvolatile storage unit of the other kind, such as a solid state drive (SSD), and so on may be used.

A monitor 104a is connected to the graphic processor 104. The graphic processor 104 displays an image on a screen of the monitor 104a in accordance with an instruction from the processor 101. The monitor 104a is, for example, a display device using a cathode ray tube (CRT), a liquid-crystal display unit, or the like.

For example, a keyboard 105a and a mouse 105b are connected to the input interface 105. The input interface 105 transmits a signal output from the keyboard 105a and the mouse 105b to the processor 101. In this regard, the mouse 105b is an example of a pointing device, and the other pointing devices may be used. The other pointing devices are, for example, a touch panel, a tablet, a touch pad, a track ball, and so on.

The optical drive unit 106 reads data recorded on an optical disc 106a using laser light, and so on. The optical disc 106a is a portable recording medium on which data is recorded so as to be read by reflection of light. The optical disc 106a is, for example, a digital versatile disc (DVD), a DVD-RAM, a compact disc-read only memory (CD-ROM), a CD-R (Recordable)/RW (ReWritable), and so on.

The device connection unit 107 is a communication interface for connecting a peripheral device to the information processing apparatus 100. For example, a memory device 107a and a memory reader/writer 107b are connected to the device connection unit 107. The memory device 107a is a recording medium provided with a communication function with the device connection unit 107. The memory reader/writer 107b is a device that writes data to the memory card 107c, or reads data from the memory card 107c. The memory card 107c is a card-type recording medium.

The communication interface 108 performs transmission and reception of data with the other devices through the network 108a, and so on.

By the above hardware configuration, the processing functions of the information processing apparatus 100 are achieved. In this regard, the information processing apparatus 10 illustrated in FIG. 1 is also achieved by a computer having the hardware illustrated in FIG. 2.

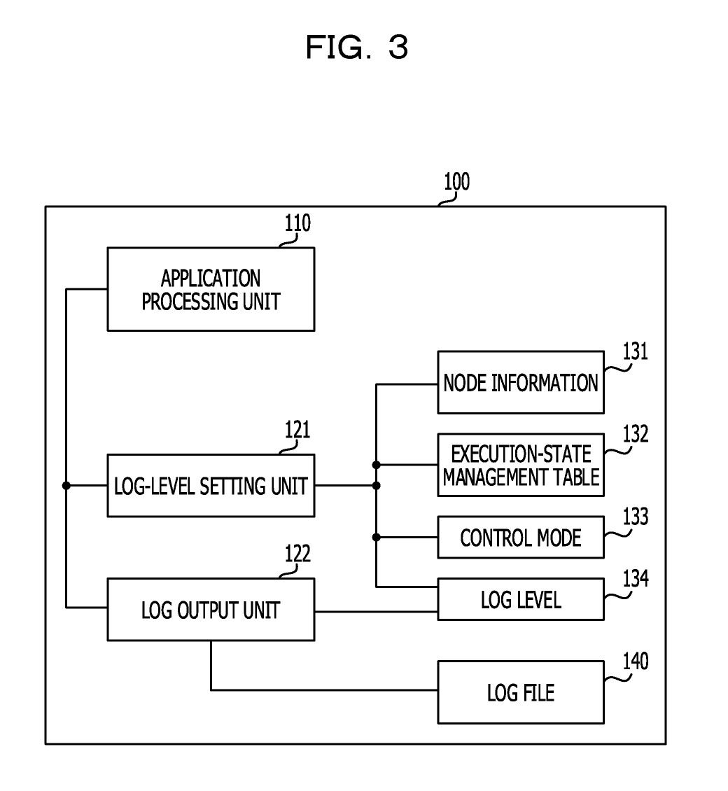

FIG. 3 is a block diagram illustrating an example of a configuration of the processing functions of the information processing apparatus. The information processing apparatus 100 includes an application processing unit 110, a log-level setting unit 121, and a log output unit 122. Also, the storage unit of the information processing apparatus 100 records node information 131, an execution-state management table 132, a control mode 133, a log level 134, and a log file 140.

The application processing unit 110 is started by the processor 101 of the information processing apparatus 100 executing a predetermined application program (hereinafter referred to as a program to be monitored) to be execution monitored by the log-level setting unit 121 and the log output unit 122. And the processing of the application processing unit 110 is achieved by the processor 101 executing the program to be monitored.

On the other hand, the processing of the log-level setting unit 121 and the log output unit 122 are achieved by the processor 101 of the information processing apparatus 100 executing the execution monitoring program, which monitors the execution of the program to be monitored and outputs the log.

The log-level setting unit 121 monitors the execution state of the application processing unit 110, and sets the log level 134 indicating the detail level with regard to the log to be output in accordance with the execution state. The log level 134 is, for example recorded in the RAM 102 of the information processing apparatus 100.

The node information 131 records, in advance, information indicating a tree structure obtained by statically analyzing the program to be monitored. The log-level setting unit 121 monitors the execution state of the application processing unit 110 for each node included in the tree structure on the basis of the node information 131.

Specifically, the log-level setting unit 121 counts the number of execution times for each “processing route”, which is a combination of a calling source node and a calling destination node, and records the information indicating the number of execution times in the execution-state management table 132. The log-level setting unit 121 increases the log level 134 on the basis of the execution-state management table 132 when the number of execution times of an executed processing route is lower a predetermined threshold value.

The control mode 133 indicates an operation mode for setting the log level 134, and is set by the log-level setting unit 121. In the present embodiment, the control mode 133 indicates on/off of the level automatic change mode for automatically changing the log level 134. In the state in which the level automatic change mode is off, the log level 134 is fixed to a predetermined level. The log-level setting unit 121 changes the level automatic change mode to off in a period immediately after execution of the application processing unit 110 is started.

The log output unit 122 writes the log in accordance with the log level 134 which was set into the log file 140. The log file 140 is created by the log output unit 122, and stored, for example into the HDD 103 of the information processing apparatus 100 or an external storage unit of the information processing apparatus 100.

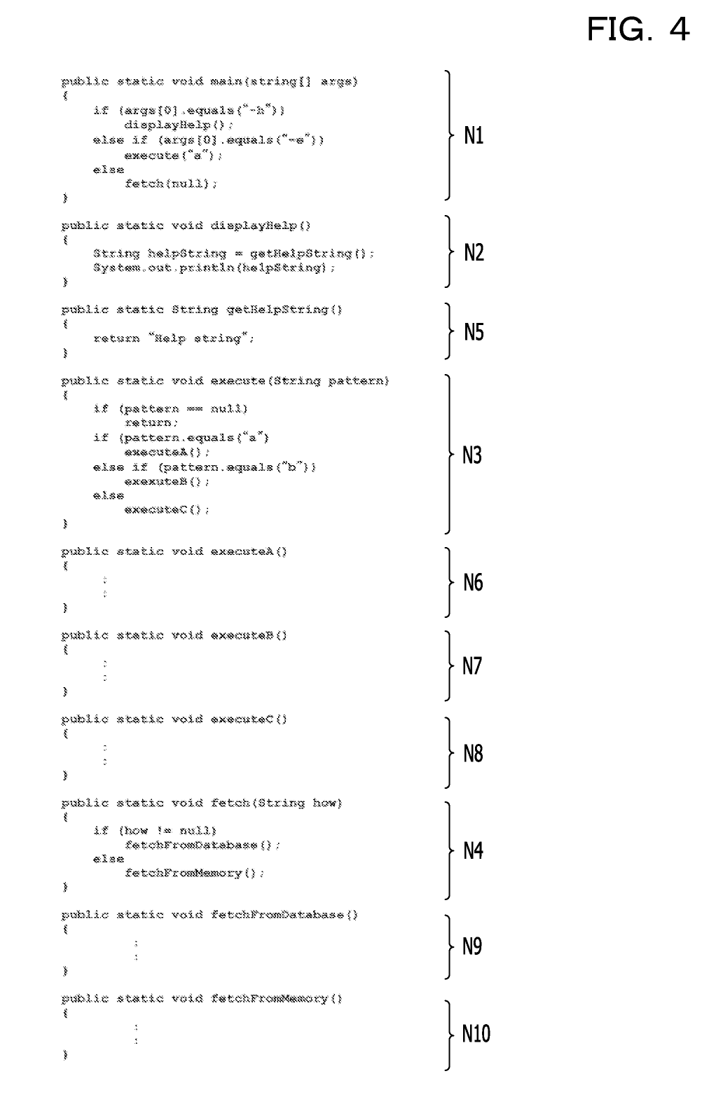

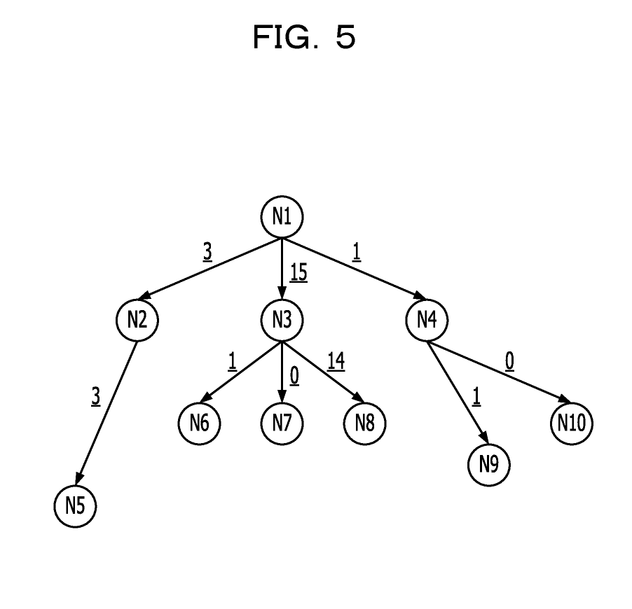

FIG. 4 is a diagram illustrating an example of source code of a program to be monitored. Also, FIG. 5 is a diagram illustrating an example of a tree structure.

It is possible to express the program to be monitored, which is illustrated in FIG. 4, by a tree structure having 10 nodes N1 to N10 as illustrated in FIG. 5 by a static analysis. Here, as illustrated in FIG. 4, each of the nodes N1 to N10 is a program module including at least one function. And the nodes N2 to N10 other than the node N1, which is a root node, are executed by the execution of the individual of the other nodes.

The node information 131 illustrated in FIG. 3 records information indicating relationships between a program to be monitored and individual nodes included in the tree structure. For example, the node information 131 records the beginning line number of each node in the source code of the program to be monitored. By the node information 131 like this, it is possible for the log-level setting unit 121 to determine which node is called by which node in the process of execution of the program to be monitored.

Also, an underlined number in FIG. 5 indicates the number of execution times of a combination of a calling source node and a calling destination node (a processing route). For example, in FIG. 5, the number of execution times of the processing route from the node N1 to the node N2 (that is to say, the number of times that the node N2 was called by the execution of the node N1) is “3”. Here, the number of execution times is the number of the times the processing route is executed from the start of execution of the program to be monitored up to now. The number of execution times for each processing route like this is counted by the log-level setting unit 121.

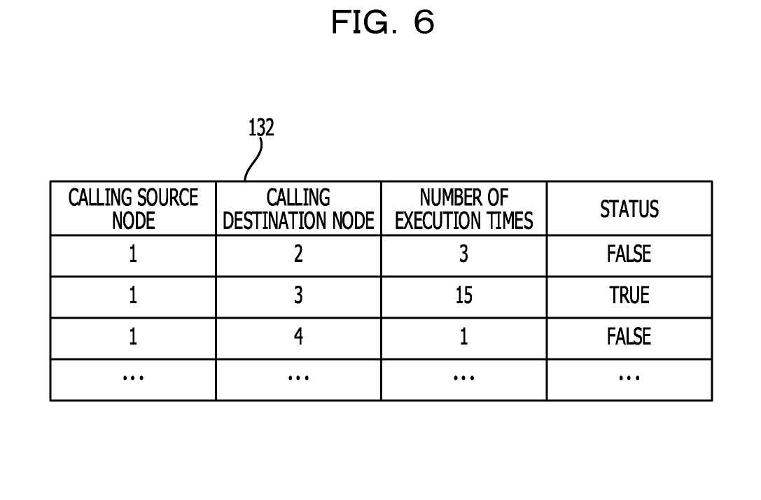

FIG. 6 is a diagram illustrating an example of information recorded in an execution-state management table. The execution-state management table 132 records the number of execution times for each processing route, which has been counted by the log-level setting unit 121. In FIG. 6, a record having a relationship in a lateral direction indicates information corresponding to one processing route. And the execution-state management table 132 includes records corresponding to all the processing routes included in the tree structure on the basis of the program to be monitored.

In FIG. 6, an identification number of a calling source node is recorded in the field of “calling source node”, and an identification number of a calling destination node is recorded in the field of “calling destination node”. A count value of the number of execution times of a corresponding processing route is recorded in the field of “number of execution times” by the log-level setting unit 121.

The log-level setting unit 121 records flag information indicating whether a corresponding value of the number of execution times is a predetermined threshold value or more in the field of “status”. In the present embodiment, the initial value of the status is “False”. When the number of execution times is the threshold value or more, the status is “True”. And when the number of execution times is lower than the threshold value, the status is “False”.

In this regard, the execution frequency (the number of execution times in a most-recent unit time) may be recorded in the execution-state management table 132 as information associated with each processing route in place of the number of execution times. In this case, if the execution frequency is the predetermined threshold value or more, the status is “True”, and if the execution frequency is lower than the threshold value, the status is “False”.

Incidentally, when a program is being executed, the probability of the occurrence of a failure is higher in a processing route that is not usually executed than in a frequently executed processing route. Also, a failure that has occurred at the time of executing a processing route that is not normally executed is often difficult to be reproduced by testing, and thus the difficulty level of investigating the cause of the occurrence of such a failure is high.

From such a viewpoint, the log-level setting unit 121 increases the log level when a processing route whose number of execution times or execution frequency is lower than the threshold value is executed on the basis of the count result of the number of execution times for each processing route. Thereby, it becomes possible to reduce the data size of the log file 140, and at the same time, to increase the probability to allow recording of a detailed log at abnormality occurrence time. Also, it becomes possible to record a detailed log at the time of the occurrence of a failure that has a high difficulty level of investigation of the cause, and thus the operation efficiency of investigation of the cause increases.

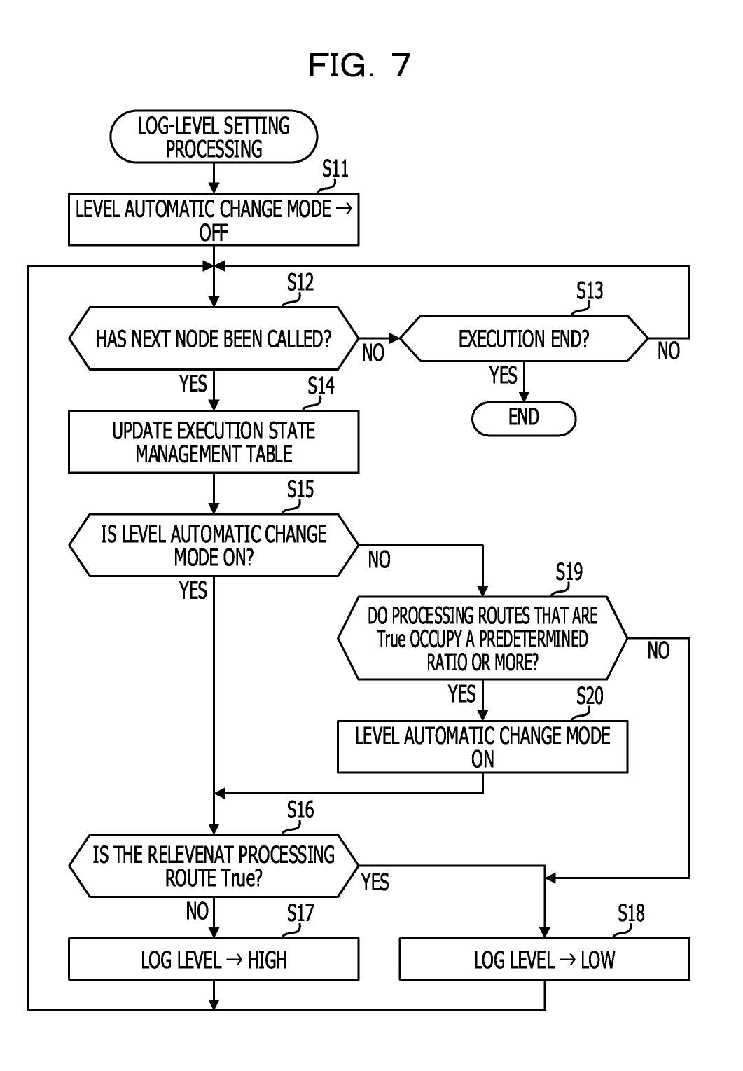

FIG. 7 is a flowchart illustrating an example of processing of a log-level setting unit. The execution of the processing in FIG. 7 is started, for example when the execution of the program to be monitored is started and the application processing unit 110 is started.

In this regard, in FIG. 7, it is assumed that the log level 134 is allowed to be set to two levels, namely, a high level and a low level as an example. For example, it is assumed that the log level 134 is allowed to be set to either the “debug” level (high level) or the “information” level (low level) among the log levels defined by log4j (a trademark of Apache Software Foundation).

Step S11: The log-level setting unit 121 turns the level automatic change mode off to perform initialization.

Step S12: The log-level setting unit 121 monitors execution of the program to be monitored, and determines whether a certain node has called a next node. If the next node has been called, the processing in step S14 is executed. If the next node has not been called, the processing in step S13 is executed.

Step S13: The log-level setting unit 121 determines whether the execution of the program to be monitored has been complete. If complete, the processing of the log-level setting unit 121 (and the log output unit 122) is terminated. On the other hand, if the execution is not complete, the processing in step S12 is executed.

Step S14: The log-level setting unit 121 increments the number of execution times associated with the relevant processing route (that is to say, a processing route corresponding to the calling source node and the calling destination node in step S12) by “1” in the execution-state management table 132. Also, the log-level setting unit 121 compares the number of execution times after the increment with a predetermined threshold value, and updates the status corresponding to the number of execution times in accordance with the comparison result. If the number of execution times is the threshold value or more, the log-level setting unit 121 sets the status to “False”, and if the number of execution times is less than the threshold value, the log-level setting unit 121 sets the status to “True”.

Step S15: The log-level setting unit 121 determines whether the level automatic change mode is on or not now. If the level automatic change mode is on, the processing in step S16 is executed, and if the level automatic change mode is off, the processing in step S19 is executed.

Step S16: The log-level setting unit 121 determines whether the status corresponding to the relevant processing route is “True” or “False” in the execution-state management table 132. If the status is “True”, the processing in step S18 is executed, and if the status is “False”, the processing in step S17 is executed.

Step S17: The log-level setting unit 121 sets the log level 134 to the high level. After this, the processing in step S12 is executed.

Step S18: The log-level setting unit 121 sets the log level 134 to the low level. After this, the processing in step S12 is executed.

In this regard, if the log level 134 is allowed to be set to three levels or more, for example, the log level 134 set in step S17 ought to be higher than the log level 134 set in step S18 (that is to say, set to have a larger amount of log data). For example, if it is assumed that the higher the log level 134, the higher the detail level with regard to the log to be output becomes, in step S17, the log level 134 of a predetermined level or more is set, and in step S18, the log level 134 lower than the predetermined level is set.

Step S19: The log-level setting unit 121 determines whether the processing route whose status is “True” among the processing routes recorded in the execution-state management table 132 is a predetermined ratio or not. If it is the predetermined ratio or more, the processing in step S20 is executed, and if it is less than the predetermined ratio, the processing in step S18 is executed.

Step S20: The log-level setting unit 121 updates the level automatic change mode from off to on.

According to the processing in FIG. 7, when a certain node calls the next node, if the number of execution times of the relevant processing route is a threshold value or more, the log-level setting unit 121 sets the log level 134 to the low level to reduce the amount of log data to be output (step S18). On the other hand, if the number of execution times of the relevant processing route is less than the threshold value, the log-level setting unit 121 sets the log level 134 to the high level (step S17). Thereby, the detail level with regard to the log output at the time of executing a processing route that is often accompanied by a failure becomes high, and the probability that allows recording of the detailed log at abnormality occurrence time increases.

However, it is not possible for the log-level setting unit 121 to correctly determine whether each processing route is frequently executed or not from the number of execution times recorded in the execution-state management table 132 in an initial period when the processing of the application processing unit 110 has started. In the initial period, the number of execution times of each processing route becomes small on the whole. Also, even if there appear processing routes having the number of execution times not less than the threshold value, that number becomes small. Accordingly, if the log level is determined on the basis of the number of execution times in the initial period, there is a probability that a large amount of log is output regardless of whether the executed processing route is actually frequently executed or not.

Thus, if the processing route whose status is “True” occupies less than a predetermined ratio (step S19: No), the log-level setting unit 121 keeps the level automatic change mode off, and sets the log level 134 to the low level (step S18). By such processing, a situation in which a large amount of log is output needlessly in the initial period is avoided.

In this regard, as described above, the execution-state management table 132 may record the execution frequency in place of the number of execution times. In this case, the processing in FIG. 7 is modified in step S14 such that the execution frequency is updated in place of the number of execution times.

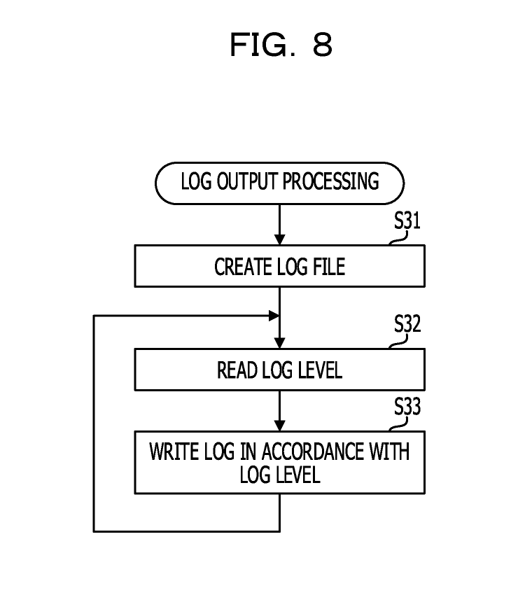

FIG. 8 is a flowchart illustrating an example of processing of the log output unit. The processing in FIG. 8 is started, for example when the execution of the program to be monitored is started and the application processing unit 110 is started in the same manner as in FIG. 7.

Step S31: When execution of the program to be monitored is started, the log output unit 122 creates the log file 140, and stores the log file 140 into the HDD 103 of the information processing apparatus 100. After that, the log output unit 122 monitors execution of the program to be monitored.

Step S32: The log output unit 122 reads the log level 134 set by the log-level setting unit 121 from the RAM 102.

Step S33: The log output unit 122 writes the log in accordance with the read log level 134 into the log file 140. The log includes, for example, date and time, a log level, a data value calculated as a result of execution of the program to be monitored, information indicating whether the processing has been executed normally, and so on. And when compared with the log of the same processing, the higher the log level 134, the larger amount of the log data is output. For example, the higher the log level 134, the larger number of items are included in the log.

The processing in steps S32 and S33 is repeatedly executed at predetermined timing, for example, each time a node is executed, and so on.

### Third Embodiment

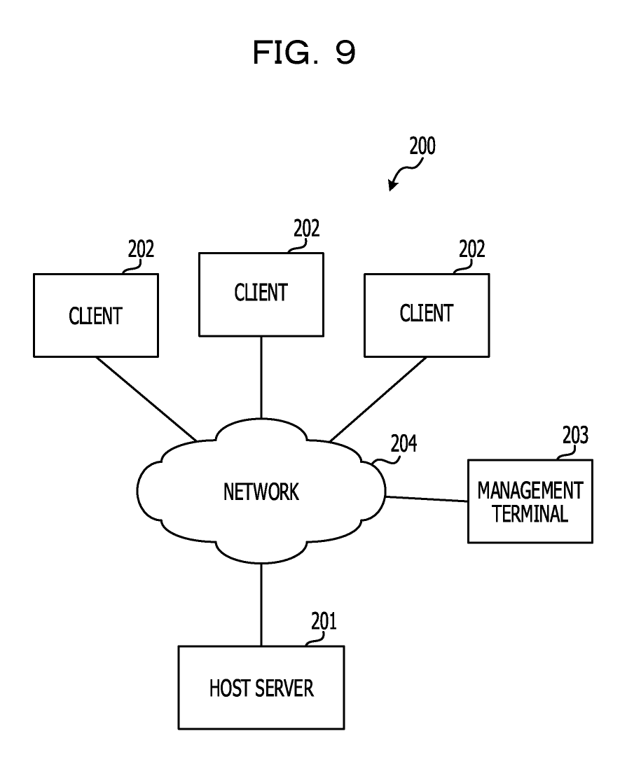

In the third embodiment, an example of the case where the information processing apparatus 10 illustrated in FIG. 1 is achieved as a host server that realizes a virtual machine. FIG. 9 is a diagram illustrating an example of a system configuration of an information processing system according to the third embodiment.

An information processing system 200 includes a host server 201, a plurality of clients 202, and a management terminal 203. The host server 201 and the individual clients 202, and the host server 201 and the management terminal 203 are mutually connected through a network 204, respectively. In this regard, it is possible to achieve all of the host server 201, the individual clients 202, and the management terminal 203 as a computer having a hardware configuration as illustrated in FIG. 2.

The host server 201 builds a Java (a registered trademark of Oracle Corporation) virtual machine, and executes various application programs on the Java virtual machine so as to provide various services to the individual clients 202.

The clients 202 are terminal apparatuses operated by users receiving the services provided by the host server 201, and access host server 201 in accordance with operation of the users.

The management terminal 203 is a terminal apparatus operated by a manager of the host server 201. The management terminal 203 accesses the host server 201, for example in response to the operation from the manager, reads the log file recorded in the host server 201, and displays the log file on a display unit (not illustrated in FIG. 9). It is possible for the manager to deal with a failure that has occurred in the host server 201 on the basis of the contents of the displayed log file.

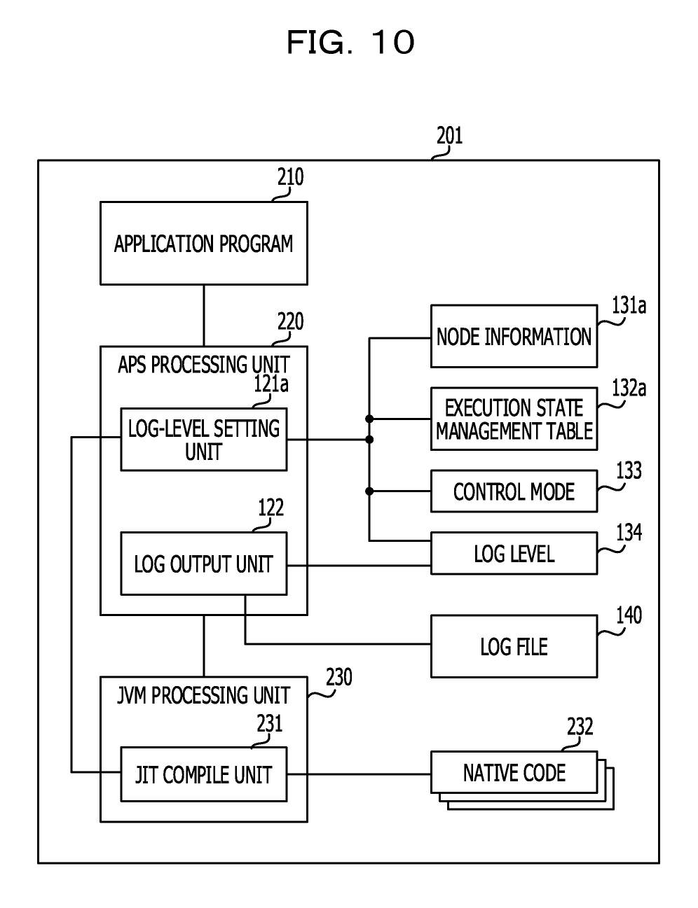

FIG. 10 is a block diagram illustrating an example of a configuration of processing functions of a host server. In this regard, in FIG. 10, a same symbol is given to a same component corresponding to that in FIG. 3, and the description thereof will be omitted.

The host server 201 includes an APS (Application Server) processing unit 220 and a JVM (Java Virtual Machine) processing unit 230. Also, the storage unit of the host server 201 records an application program 210, node information 131a, an execution-state management table 132a, a control mode 133, a log level 134, and a log file 140.

The application program 210 corresponds to the program to be monitored in the second embodiment. The application program 210 is executed on the Java virtual machine.

The processing of the JVM processing unit 230 is achieved by the processor (not illustrated in FIG. 10) of the host server 201 executing the JVM program. The JVM processing unit 230 executes the processing as a Java virtual machine. The JVM processing unit 230 obtains the source code of the application program 210 through the APS processing unit 220, and performs processing as the Java virtual machine in accordance with the application program 210.

The processing of the APS processing unit 220 is achieved by the processor of the host server 201 executing the APS program. The APS processing unit 220 monitors the execution state of the application program 210 on the Java virtual machine, and outputs the log. The APS processing unit 220 includes a log-level setting unit 121a, and a log output unit 122.

The log-level setting unit 121a monitors the execution of the application program 210 in units of a node of the tree structure obtained by a static analysis of the application program 210 in the same manner as the log-level setting unit 121 in FIG. 3. Also, the node information 131a records information indicating relationship between the application program 210 and each node included in the tree structure. Here, a node in the present embodiment is a Java method, and the log-level setting unit 121a monitors the execution of the application program 210 in units of a Java method on the basis of the node information 131a. The Java method is a program module included in the application program 210.

The log-level setting unit 121a outputs the log level 134 indicating the detail level with regard to the log to be output in accordance with the execution state of the application program 210 to be monitored. However, unlike the log-level setting unit 121 in FIG. 3, the log-level setting unit 121a sets the log level 134 on the determination of the execution state of the application program 210 using the Java-method execution management function included in the JVM processing unit 230.

The JVM processing unit 230 uses the following two methods at the time of executing the application program 210. One is an interpreter method in which intermediate code (byte code) obtained from conversion of the application program 210 is interpreted and executed in sequence. The other is a JIT (Just In Time) compile method in which intermediate code is compiled for each predetermined range into native code, and then the native code is executed.

The JVM processing unit 230 includes a JIT compile unit 231 that executes the application program 210 by the JIT compile method like this. In the present embodiment, the JIT compile unit 231 converts the intermediate code into native code for each Java method.

The JVM processing unit 230 executes the application program 210 basically by an interpreter method. At the same time, the JIT compile unit 231 monitors the execution state of each Java method by counting the number of execution times for each Java method, and so on. The JIT compile unit 231 determines a Java method that ought to be converted into the native code 232 on the basis of the analysis result of the execution state. Basically, the larger the number of Java methods that are executed repeatedly, the higher the execution speed using the JIT compile method becomes. Accordingly, the JIT compile unit 231 determines, for example a Java method having the number of execution times or the execution frequency of a threshold value or more is a Java method to be converted into the native code 232.

And when a Java method having been determined to be converted into the native code 232 is called, the JIT compile unit 231 converts the Java method into the native code 232, and executes the native code 232. Also, the JIT compile unit 231 stores the converted native code 232 into the storage unit (for example, a RAM) of the host server 201. And after that, if a Java method that has been converted into the native code 232 is called, the JIT compile unit 231 executes the converted native code 232. In this regard, the JIT compile unit 231 may convert a Java method that ought to be converted into the native code 232 before the Java method is called next into the native code 232, and store the native code 232 into the RAM.

The log-level setting unit 121a inquires whether each Java method has been converted into the native code 232 or not, and records the inquiry result in the execution-state management table 132a. And when a Java method is called, if the called Java method has not been converted into the native code 232, the log-level setting unit 121a determines that the Java method has not been frequently executed, and thus increases the log level 134.

The log output unit 122 writes the log in accordance with the set log level 134 into the log file 140 in the same manner as the log output unit 122 in FIG. 3.

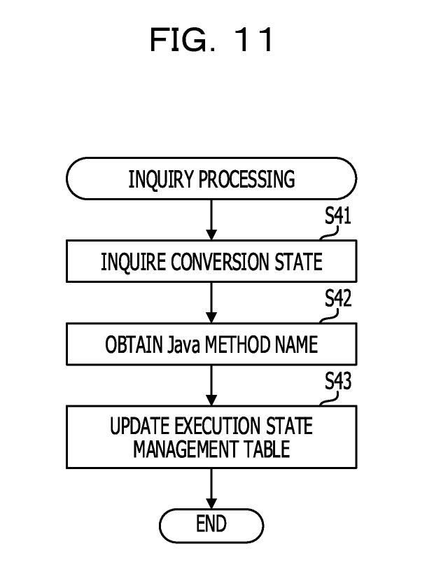

FIG. 11 is a flowchart illustrating an example of inquiry processing by the log-level setting unit. The log-level setting unit 121a executes the processing in FIG. 11, for example repeatedly at regular intervals.

Step S41: The log-level setting unit 121a inquires of the JIT compile unit 231 as to a conversion state to the native code 232 for each Java method. For example, in “Java HotSpot Server VM”, which is a JVM program of Oracle Corporation, it is possible to obtain an identification name of a Java method for which a compilation request to the native code 232 has occurred using the “PrintCompilation” command.

Step S42: The log-level setting unit 121a obtains the identification name of the Java method that has been converted to the native code 232 from the JIT compile unit 231.

Step S43: The log-level setting unit 121a records information indicating whether having been converted into the native code 232 or not in the execution-state management table 132a for each Java method to update the execution-state management table 132a.

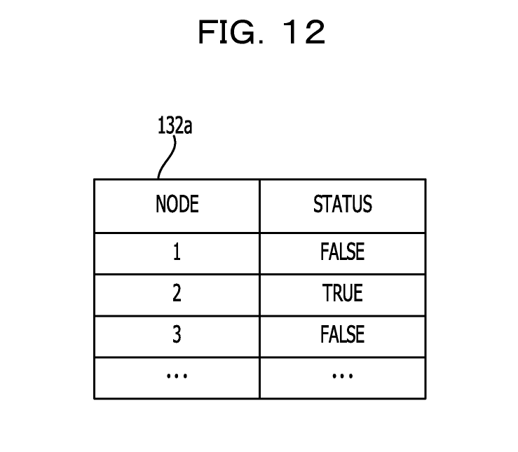

FIG. 12 is a diagram illustrating an example of information recorded in the execution-state management table. The execution-state management table 132a records the status for each node included in the tree structure of the application program 210. Each node corresponds to a Java method. The status indicates whether the corresponding node has been converted into the native code 232 or not. In the present embodiment, the initial value of the status is “False”, the status in the case of having been converted into the native code 232 is “True”, and the status in the case of not having been converted is “False”.

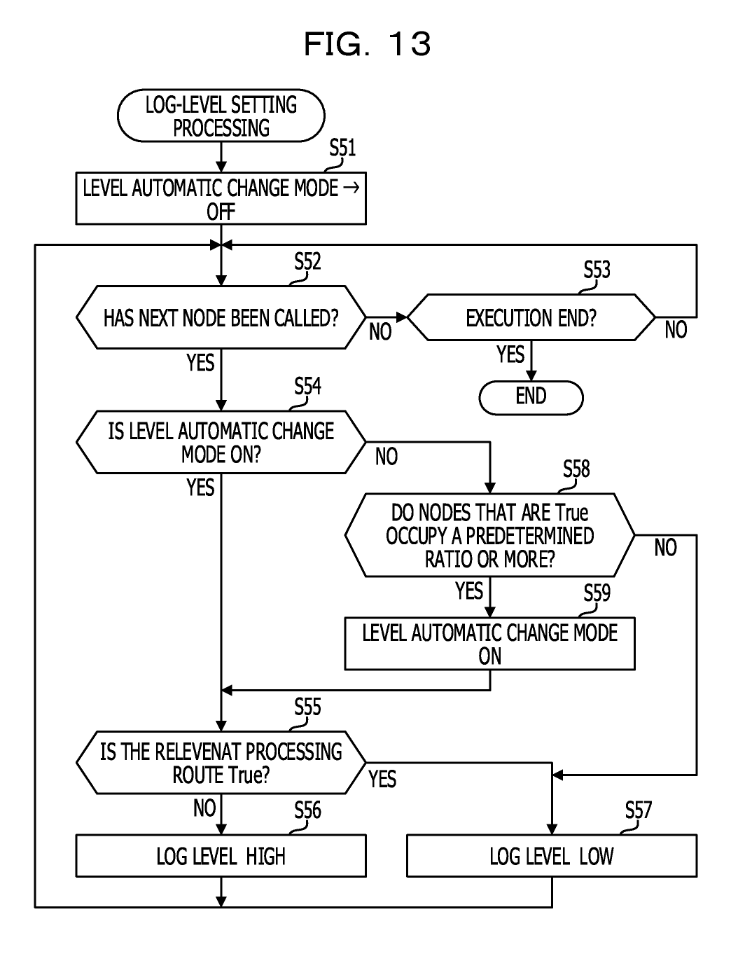

FIG. 13 is a flowchart illustrating an example of log-level setting processing. The processing in FIG. 13 is executed, for example when the execution of the application program 210 is started. In this regard, it is assumed that the log level 134 is allowed to be set to two levels, namely, a high level and a low level in the same manner as in FIG. 13 and FIG. 7.

Step S51: The log-level setting unit 121a turns the level automatic change mode off to perform initialization.

Step S52: The log-level setting unit 121a monitors the execution of the application program 210, and determines whether a certain node has called the next node. A node mentioned here corresponds to a Java method. If the next node has been called, the processing in step S54 is executed, and if the next node has not been called, the processing in step S53 is executed.

Step S53: The log-level setting unit 121a determines whether the execution of the application program 210 has been complete. If the execution has been complete, the processing of the log-level setting unit 121a (and log output unit 122) is terminated. On the other hand, if the execution has not been complete, the processing in step S52 is executed.

Step S54: The log-level setting unit 121a determines whether the level automatic change mode is on now. If the level automatic change mode is on, the processing in step S55 is executed, and if the level automatic change mode is off, the processing in step S58 is executed.

Step S55: The log-level setting unit 121a determines whether the status corresponding to the relevant node (that is to say, the node that has been called in step S52) is “True” or “False” in the execution-state management table 132a. If the status is “True”, the processing in step S57 is executed, and if the status is “False”, the processing in step S56 is executed.

Step S56: The log-level setting unit 121a sets the log level 134 to the high level. After that, the processing in step S52 is executed.

Step S57: The log-level setting unit 121a sets the log level 134 to the low level. After that, the processing in step S52 is executed.

Step S58: The log-level setting unit 121a determines whether nodes whose status are “True” out of the nodes recorded in the execution-state management table 132a occupy a predetermined ratio or more. If the predetermined ratio or more, the processing in step S59 is executed, and if less than the predetermined ratio, the processing in step S57 is executed.

Step S59: The log-level setting unit 121a updates the level automatic change mode from off to on.

According to FIG. 13, when a node is called, if the node has been converted into the native code 232, the log-level setting unit 121a sets the log level 134 to the low level to reduce the amount of log data to be output (step S57). On the other hand, when a node is called, if the node has not been converted into the native code 232, the log-level setting unit 121a determines that the node is not frequently executed, and thus sets the log level 134 to the high level (step S56). Thereby, the detail level with regard to the log that is output at the time of executing a processing route in which a failure is likely to occur becomes high, and thus a probability that allows recording of the detailed log at abnormality occurrence time increases.

Also, in the initial period in which the execution of the application program 210 has been started, it is difficult for the log-level setting unit 121a to correctly determine whether each processing route is frequently executed or not from the information of whether each node has been converted into the native code 232 or not. Thus, if nodes whose status is “True” occupy less than a predetermined ratio (step S58: No), the log-level setting unit 121a keeps the level automatic change mode off, and sets the log level 134 to the low level fixedly (step S57). Thereby, it is possible to avoid a situation in which a large amount of log is output needlessly in the initial period.

In this regard, in the above-described processing in FIGS. 11 to 13, the log-level setting unit 121a records whether the Java method has been converted into the native code 232 or not in the execution-state management table 132a before the Java method is called. However, as another method, the log-level setting unit 121a may inquire of the JIT compile unit 231 when a Java method is called, and may determine whether the Java method has been converted into the native code 232 or not from a result of the response.

In the third embodiment, the log-level setting unit 121a determines whether a node is frequently executed or not using a function included in the JIT compile unit 231, and sets the log level 134 from the determination result. Accordingly, the processing of the APS processing unit 220 is simplified, and the processing load is reduced. Also, the volume of data of the program for achieving the processing of the APS processing unit 220 is reduced.

In this regard, it is possible to achieve the processing functions of the apparatuses described in the above-described embodiments (for example, the information processing apparatuses 10 and 100, and the host server 201) by a computer. In that case, programs describing the processing contents of the functions to be possessed by each of the apparatuses are provided, and the programs are executed on the computer so that the above-described processing functions are achieved on the computer. It is possible to record the programs describing the processing contents in a computer-readable recording medium. The computer-readable recording medium is, for example, a magnetic storage unit, an optical disc, a magnetic optical recording medium, a semiconductor memory, and so on. The magnetic storage unit is, for example, a hard disk (HDD), a flexible disk (FD), a magnetic tape, and so on. The optical disc is, for example, a DVD, a DVD-RAM, a CD-ROM, a CD-R/RW, and so on. The magnetic optical recording medium is, for example, a Magneto-Optical disk (MO) and so on.

In the case of distributing the program, for example, a portable recording medium, such as a DVD, CD-ROM, and so on, on which the program is recorded is marketed. Also, the program may be stored in a storage unit of a server computer, and the program may be transferred from the server computer to another computer through the network.

The computer on which the program is executed stores, for example, the program recorded in the portable recording medium or the program transferred from the server computer into its own storage unit. And the computer reads the program from the own storage unit, and executes the processing in accordance with the program. In this regard, the computer may directly read the program from the portable recording medium, and may execute the processing in accordance with the program. Also, the computer may execute the processing in accordance with the received program in sequence each time the program is transferred from the server computer connected through the network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus for executing a program, the information processing apparatus comprising:
a memory; and
a processor coupled to the memory and configured to:
set a detail level with regard to a log based on a number of times of prior execution of a program module called, the program module being included in the program, and
output the log including information in accordance with the detail level.

2. The information processing apparatus according to claim 1,
wherein the program includes a plurality of program modules, and
the processor is configured to:
count a number of execution times or an execution frequency for each combination of calling source program modules and calling destination program modules among the plurality of program modules, and
increase the detail level when the number of execution times or the execution frequency for each combination of the program modules called and the calling source program modules thereof is lower than a threshold value.

3. The information processing apparatus according to claim 2,
wherein the processor is configured to set the detail level not greater than a certain value when a ratio of combinations having the number of execution times or the execution frequency not lower than the threshold value to all the combinations of the calling source program modules and the calling destination program modules is lower than a predetermined value.

4. The information processing apparatus according to claim 1,
wherein the processor is configured to increase the detail level when the number of execution times or the execution frequency of the program modules called is lower than a threshold value.

5. The information processing apparatus according to claim 4,
wherein the program includes a plurality of program modules, and
the processor is configured to set the detail level not greater than a certain value when a ratio of program modules having the number of execution times or the execution frequency not lower than the threshold value to the plurality of program modules is lower than a predetermined value.

6. The information processing apparatus according to claim 1,
wherein the program includes a plurality of program modules,
wherein the processor is configured to:
determine whether to compile each of the plurality of program modules into native code based on the number of execution times,
execute the program modules after compiling the program modules determined to be compiled into native code, and
increase the detail level when the program modules called have not been compiled into the native code.

7. A method of outputting a log in an information processing apparatus that executes a program, the method comprising:
setting a detail level with regard to a log based on a number of times of prior execution of a program module called, the program module being included in the program, and
outputting the log including information in accordance with the detail level set by the setting.

8. The method according to claim 7,
wherein the program includes a plurality of program modules,
wherein the method further comprising:
counting a number of execution times or an execution frequency for each combination of calling source program modules and calling destination program modules among the plurality of program modules,
wherein the setting includes increasing the detail level when the number of execution times or the execution frequency for each combination of the program modules called and the calling source program modules thereof is lower than a threshold value.

9. The method according to claim 8,
wherein the setting sets the detail level not greater than a certain value when a ratio of combinations having the number of execution times or the execution frequency not lower than the threshold value to all the combinations of the calling source program modules and the calling destination program modules is lower than a predetermined value.

10. The method according to claim 7,
wherein the setting includes increasing the detail level when the number of execution times or the execution frequency of the program modules called is lower than a threshold value.

11. The method according to claim 10,
wherein the program includes a plurality of program modules, and
the setting sets the detail level not greater than a certain value when a ratio of program modules having the number of execution times or the execution frequency not lower than the threshold value to the plurality of program modules is lower than a predetermined value.

12. The method of outputting a log according to claim 7,
wherein the program includes a plurality of program modules,
wherein the method further comprising:
determining whether to compile each of the plurality of program modules into native code based on the number of execution times; and
executing the program modules after compiling the program module determined to be compiled into native code by the determining,
wherein the setting sets the detail level when the program modules called have not been compiled into the native code.

13. A non-transitory computer-readable recording medium storing a program causing an information processing apparatus to execute a process, the process comprising:
setting a detail level with regard to a log based on a number of times of prior execution of a program module called, the program module being included in a certain program executed by the information processing apparatus; and
outputting the log including information in accordance with the detail level set by the setting.

14. The computer-readable recording medium according to claim 13,
wherein the certain program includes a plurality of program modules,
wherein the process further comprising:
counting a number of execution times or an execution frequency for each combination of calling source program modules and calling destination program modules among the plurality of program modules,
wherein the setting includes increasing the detail level when the number of execution times or the execution frequency for each combination of the program modules called and the calling source program modules thereof is lower than a threshold value.

15. The computer-readable recording medium according to claim 14,
wherein the certain program includes a plurality of program modules,
wherein the setting sets the detail level not greater than a certain value when a ratio of combinations having the number of execution times or the execution frequency not lower than the threshold value to all the combinations of the calling source program modules and the calling destination program modules is lower than a predetermined value.

16. The computer-readable recording medium according to claim 13,
wherein the setting includes increasing the detail level when the number of execution times or the execution frequency of the program modules called is lower than a threshold value.

17. The computer-readable recording medium according to claim 16,
wherein the certain program includes a plurality of program modules,
the setting sets the detail level not greater than a certain value when a ratio of program modules having the number of execution times or the execution frequency not lower than the threshold value to the plurality of program modules is lower than a predetermined value.

18. The computer-readable recording medium according to claim 13,
wherein the certain program includes a plurality of program modules,
wherein the process further comprising:
determining whether to compile each of the plurality of program modules into native code based on the number of execution times; and
executing the program modules after compiling the program module determined to be compiled into native code by the determining,
wherein the setting sets the detail level when the program module called has not been compiled into the native code.
